(19) United States
(12) Patent Application Publication
(10) Pub. No.: US 2015/0026588 A1
(43) Pub. Date: Jan. 22, 2015

(54) INTEGRATED COMBAT RESOURCE MANAGEMENT SYSTEM

(71) Applicant: THALES CANADA INC., Toronto (CA)

(72) Inventors: Stephane Turcotte, Quebec (CA); Remi Blanchette, Val-Belair (CA); David Belanger, Charlesbourg (CA); Francois Rioux, Gatineau (CA); Martin Rivest, Quebec (CA); Paul Romano, Nepean (CA); Bill Curry, Orleans (CA)

(21) Appl. No.: 13/912,513

(22) Filed: Jun. 7, 2013

Related U.S. Application Data
(60) Provisional application No. 61/657,337, filed on Jun. 8, 2012.

(51) Int. Cl. G06F 3/0484; G06F 3/0488; G06F 3/0482; H04W 4/00; H04W 4/02

(52) U.S. Cl. CPC G06F 3/0484; H04W 4/001; H04W 4/02; G06F 3/0482; G06F 3/0488
USPC 715/745

(57) ABSTRACT

An integrated combat resource management device is in the form of a smartphone with a display screen and user input device. The smartphone has a set of integrated applications stored therein which when executed provide an interactive display offering dynamic real-time situational awareness information to the user. Configuration files contain user-specific profiles. A launcher application offers access control and the management of several user profiles on the same smartphone such that upon successful login the appropriate user-specific profile is applied.

### CROSS REFERENCE TO RELATED APPLICATION

This application claims priority from U.S. provisional application No. 61/657,337, filed Jun. 8, 2012, the contents of which are herein incorporated by reference.

### FIELD OF THE INVENTION

This invention relates to an integrated combat resource management system, for example for use on a battlefield or similar environment, but it is also applicable to other management situations, such as for police or emergency responders.

### BACKGROUND OF THE INVENTION

In a high pressure environment, such as exists on a battlefield, it is important that personnel be provided with as much information about their surroundings as possible in order to give them the highest situational awareness without overwhelming their ability to absorb and use the information.

Typical battle management systems for the soldier run on PCs using standard operating systems. The user experience is therefore sub-optimal since such systems are not designed to be used with mobile devices and do not take advantage of the capabilities of modern mobile consumer smartphones, such as Android-based smartphones, which are readily available at modest cost.

A user who uses such a PC-based system has to learn from scratch the user interaction that this kind of systems entails, whereas users are often already familiar with smartphone user interface paradigm.

Navigation systems exist that allow users displaying background map as well as few points of interest. However, the content is static and does not allow for real-time communication with remote users.

User interfaces are not optimized for touch screen mobile devices.

Current technologies do not integrate as many useful features for the soldier packaged in a natural and intuitive way.

Typical Android smartphones/PDAs do not allow for more than one user profile to be present on one device. This limitation is acceptable for consumer products, but in the context of soldiers deployment on the ground it is unacceptable. Therefore, standard Android applications launchers cannot be used.

Typical communication network among smartphones is based on the client/server architecture; however, the configuration in the field is too dynamic to permit establishment of a server, so a peer to peer network is needed. Furthermore, there cannot be a single point of failure that would disable communication between individuals, which further rules out the server option and reinforces a peer-to-peer architecture.

WO9727528, WO100642, and U.S. Pat. No. 5,864,481 are examples of a PC-based systems.

### SUMMARY OF THE INVENTION

According to the present invention there is provided an integrated combat resource management system comprising a smartphone with a display screen and user input device, wherein the smartphone has a set of integrated applications stored therein which when executed provide an interactive display offering dynamic real-time situational awareness information to the user, configuration files containing user-specific profiles, and a launcher application that offers access control and the management of several user profiles on the same smartphone such that upon successful login the appropriate user-specific profile is applied.

It will be understood that the invention extends to other field resource management systems, such as emergency response or policing situations.

The invention provides an integrated combat resource management system for a smartphone based, for example, on the Android operating system, for a dismounted soldier. It involves mobile applications software development (on Android), geographical information systems, peer-to-peer networking, and mobile applications security. It is also applicable to other similar environments, such as in emergency situations. Other potential fields include police, first responders, casual gaming such as paintball.

The advantages of the invention include the integration of a software suite that runs on Android, which is typically used for consumer applications. Whereas typical Android phones only support one user profile, the invention supports several user profiles through the use of a custom Android launcher and associated configuration file. Peer-to-peer networking allows soldiers for data exchange through a transparent mesh radio network.

In one embodiment the invention provides a set of Android applications that are integrated in such a way that the soldier can accomplish his/her mission as effectively as possible. A graphical user interface makes use of a touch screen with which the user interacts. The system takes advantage of the Android operating system that is optimized for mobile applications that use a touch screen device.

With its custom Android launcher, one embodiment of the invention allows several user profiles to be loaded on one Android device. User login/password combinations as well as user-specific settings are stored in configuration files that are loaded when the PDA is booted up. Then a user can enter his/her credentials and soldier-specific applications are notified of the logged in user, applying proper settings.

With its integrated communications network, embodiments of invention allow users to exchange data among nodes, which in turn results in dynamic content being displayed on the main application that includes a geographical information system. Therefore, the soldier is able to be aware of changing situations in real-time.

The invention may be implemented using the standard Android software development kit, and make use of hardware present on a PDA (e.g., electronic compass, GPS, camera) as well as external devices (e.g., USB drive, laser range finder). It may consists of several Android applications, the most important ones being: an application that includes a geographical information system and a network service that manages the peer-to-peer communication; an Android launcher replacement that allows for access control and for the management of several user profiles on the same Android device.

Embodiments of the invention may offer the following advantages: natural use of menu systems through main menu and quick actions menu available on individual entities; secure multiple users support on Android; custom home screen that only provides applications useful for the soldier; peer-to-peer networking that allows users to be part of; geographical information system that includes configurable set of layers, situation awareness and terrain analysis; display of friendly units, including support for aggregation based on the Order of Battle and zoom level; navigation on routes that provides a bearing indicator and navigation panel; text messaging; generic reports and returns; system configuration through external configuration files; and external interfaces to connect various hardware devices.

Embodiments of the invention offer integrated functionalities that the soldier needs to accomplish his/her work in a natural and easy to use graphical user interface, multiple user login on an Android device, custom quick actions menu that allows easy access to details about entities on the map as well as associated actions, and a peer-to-peer networking implementation that filters packets at the application level and handles communities of interest.

### BRIEF DESCRIPTION OF THE DRAWINGS

The invention will now be described in more detail, by way of example only, with reference to the accompanying drawings, in which:

FIG. 1 is a block diagram of a typical field management system in accordance with an embodiment of the invention;

FIG. 2 is a chart illustrating the software implementation of one embodiment for the invention; and

FIG. 3-15 are screen shots illustrating various aspects of the system.

### DETAILED DESCRIPTION OF THE INVENTION

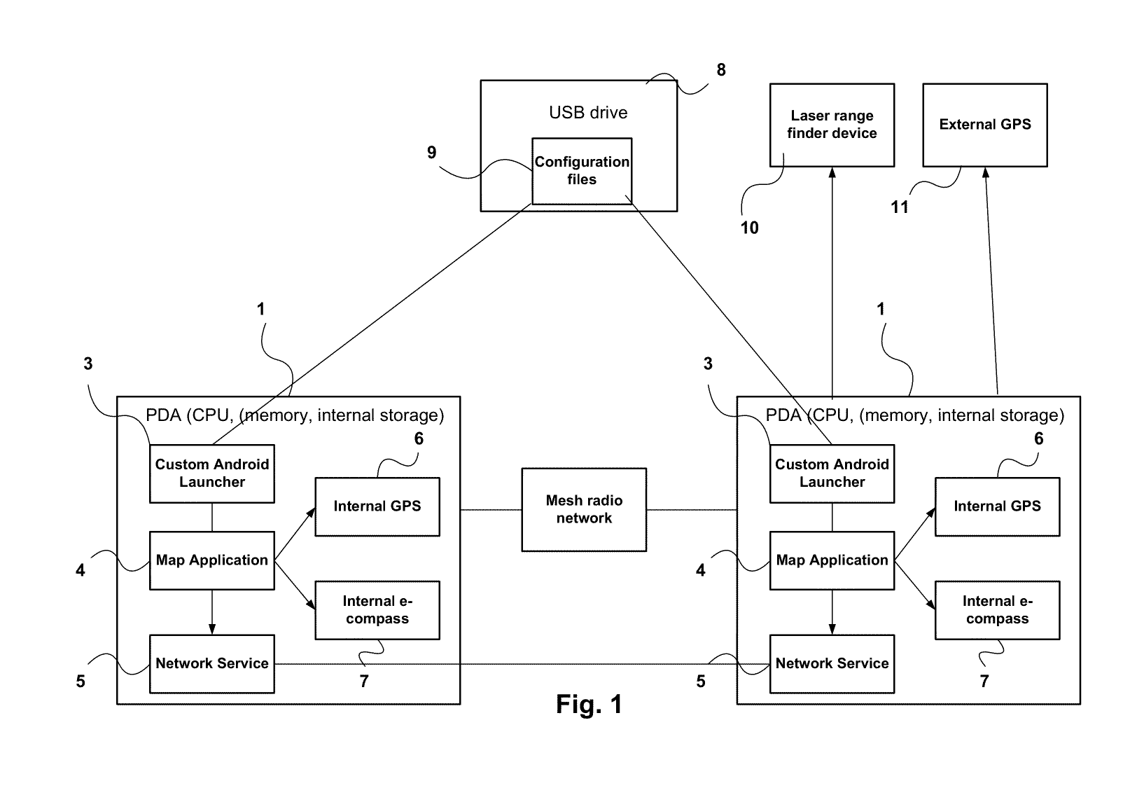

FIG. 1 illustrates an embodiment of the invention designed to run on an Android smartphone, such as a Samsung Galaxy with a processor, and a touch-sensitive display screen for displaying information and accepting user input. The system comprises a suite of applications that run on the smartphone.

In one example shown in FIG. 1, a complete system comprises two smartphones 1, 2, each running the suite of applications consisting of the Android launcher app 3, the map application 4, and the network service 5.

The map application 4 interfaces with the internal GPS 6 and internal electronic compass 7.

Each smartphone 1, 2 can connect through a USB port to a USB drive 8 storing configuration files 8. The smartphones may also communicate with external devices, such as laser range finder 10 and external GPS 11 through a USB port or like connection.

The main application is a geographical information system 4 that includes many features that are useful to the soldier. Even if those features are numerous, they are organized in such a way that they are easily accessible in order to avoid increasing the cognitive load of the user. Features include a navigation function that relies on the user inputting waypoints and routes that can be navigated. The navigation panel displays useful information such as the current speed and bearing, the estimated time of arrival to the last waypoint, etc. A bearing indicator is always displayed to the user so that it is possible to become oriented at any time. Reports and returns are easily accessible through the main menu that is shown via the Android menu button. A text messaging application is accessible via the home screen. The map application displays events on the map that are reported by other nodes through the network.

A user can also freehand-draw on the map, and place quick symbols. Those features altogether packaged in a single application meet the need to provide a soldier with a set of useful tools that are intuitive to use and that do not increase the cognitive load.

Multiple user login on Android is rendered possible through a home screen replacement. User credentials are stored in a configuration file that is loaded from the external data storage 8. The launcher replacement does not provide access to the user to the home screen until proper login/password credentials are entered. The system can also lock itself up upon a number of unsuccessful login/password entries. The custom launcher is therefore a secure way of ensuring that only users that should have access to the system are allowed to access it, and supports multiple users. The launcher application provides access to other applications as to which user is currently logged in, which makes it possible for third party application to load specific profiles for specific users. For example, the map application will load a different profile for a Commander and for a Rifleman.

The main menu has been implemented such that the map underneath is always visible, the menu being transparent. Information is organised in such a way that most commonly used and timely actions are at the top, and the others in between. Actions that do not fit on one screen can be accessed by a scrolling gesture or by accessing scroll buttons.

Customized “quick actions” menus allow easy access to details about entities on the map as well as associated actions. These “quick actions” menus are transparent as well, allowing a user to always see the map underneath. The information architecture has also been studied such that users have access to most frequently used actions at the top.

The network service 5 provides peer-to-peer communication in a mesh radio network and as such is not susceptible to single point failure. The implementation relies on standard Internet protocol (IP) communication and a reliable multicast library. Once communication is established, messages can be exchanged among nodes on a peer-to-peer basis. Each device can communicate with any other device in range on a one to one basis, and may communicate with devices out of range using intermediate devices to relay the message (the mesh radio could, for example, use the Wi-Fi feature built into the smartphones to create a secure local mesh network). The smartphone may also make use of cellular frequencies if required, for example, to a local base station established for the purpose.

Messages are encoded using a special mechanism that relies on Java Reflection in order to detect the fields to be encoded and decoded. Nodes can thus exchange data in pre-formatted messages such as positional message, contact report, call for fire, call for medic, text message, etc.

Message delivery is ensured by a data dispatcher that reads the message header and decides whether or not its node should process the data further. This header is adjusted by the sender node, who can decide the recepients by selecting either individual nodes or communities of interest. Communities of interest are groups of nodes that need to exchange data. They can be joined or left to the user's choice.

The embodiment is based on Android applications using conventional software libraries such as Android, an off-the-shelf GIS engine, and a reliable multicast library.

The suite of multi-purpose applications all have the same look and feel and therefore do not increase the cognitive load of a soldier as he performs his job.

Multiple user support allows than one user profile to be stored on one PDA or smartphone.

The use of the peer-to-peer communication network means no single point of failure in the network since everybody sends every message to everybody else.

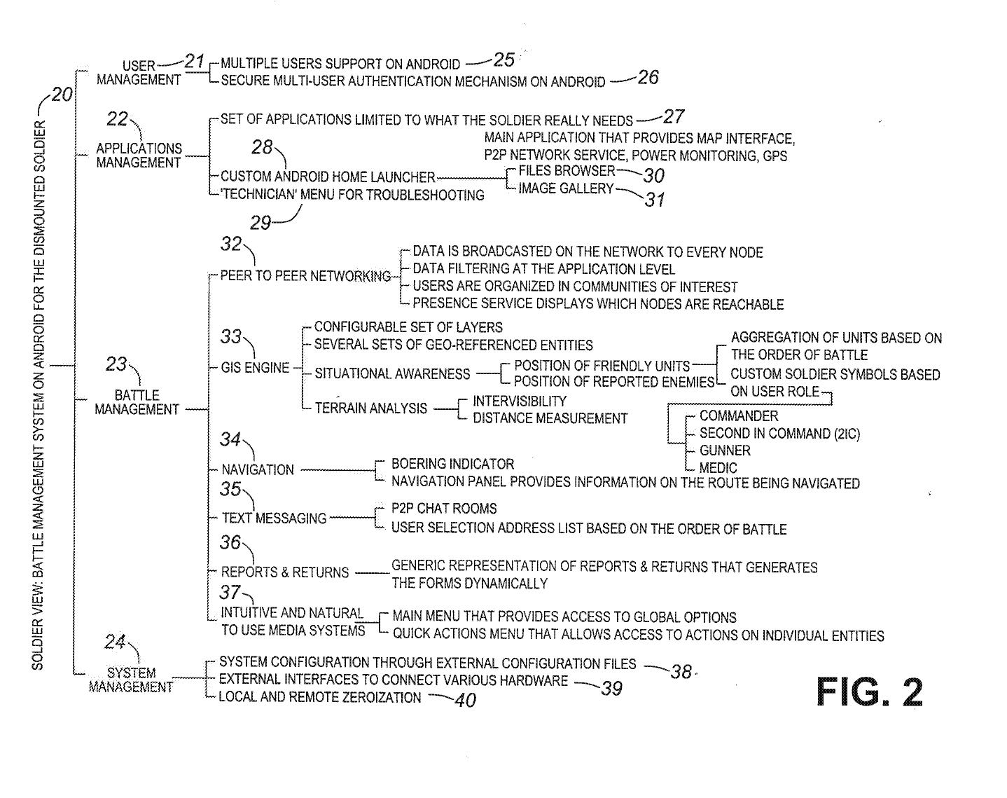

FIG. 2 shows details of the software system. The management system 20 is broken down into four main sub-systems, a user management sub-system, an applications management system 22, a battle management sub-system 23, and a system management system 24,

The user management sub-system comprises support for multiple users 25 and a secure multi-user authentication system 26.

The applications sub-management system comprises a set of applications 27 designed to limit information to a specific subset in order not to overwhelm the soldier, an Android launcher 28, and a technical menu 29. The launcher application 28 provides files browser 30 and image gallery 31.

The battle management subsystem 23 comprises a peer-to-peer networking module 32, a GIS engine 33, a navigation module 34, a text messaging module 35, a module 36 for reports and a module 37 providing intuitive menu systems.

The peer-to-peer networking module 32 handles the broadcasting of data to every node, data filtering at the application level, organization of users in communities of interest, and presence service displays indicating which nodes are reachable.

The GIS engine 33 provides a configurable set of layers, sets of geo-referenced entities, situation awareness, and terrain analysis.

The situational awareness provides the position of friendly units, position of reported enemies and further detail as illustrated,

The navigation module 34 provides a bearing indicator and a navigation panel with route information.

The text messaging module 35 provides peer-to-peer chat rooms and a user selection address list.

The reports and returns module 36 generates forms dynamically from a generic representation.

Module 37 provides a main menu giving access to global options and a quick actions menu that allows access action on individual entities.

The system management subsystem comprises a system configuration module allowing configuration of the device through external configuration files, external interfaces 39 to connect to various external hardware, and local and remote resetting or “zeroization”.

The above system as noted is implemented using software applications written for the Android operating system, although it will be understood that it could also be written for other mobile operating systems, such as Apple's IOS 5.1.

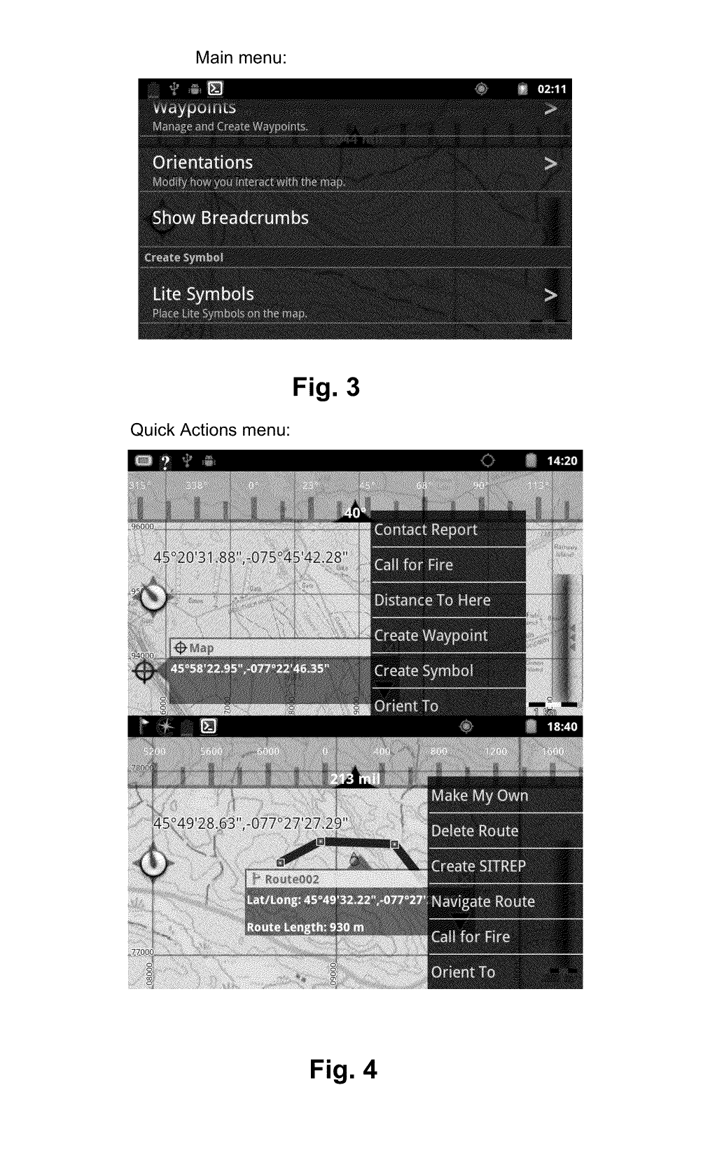

FIGS. 3 to 15 show exemplary screen shots available to the user, which are implemented using apps written in the Android operating system.

FIG. 3 illustrates a portion of the main menu, which allows the user to set up the system. For example, the user may enter in advance specific waypoints, and set user preferences. Orientations allows the user to modify how the user interacts with the map. Show breadcrumbs allows the user to configure the GIS system to show a breadcrumb trail of the user's path. Lit Symbols allows the user to place symbols on the map.

FIG. 4 illustrates a typical quick action menu, which may drop down over a navigation screen, for example, allowing the user to file a contact report or call for fire. For example, if the user activates the “call-for-fire” item a request is transmitted over the network for fire along with any relevant geographical or other information.

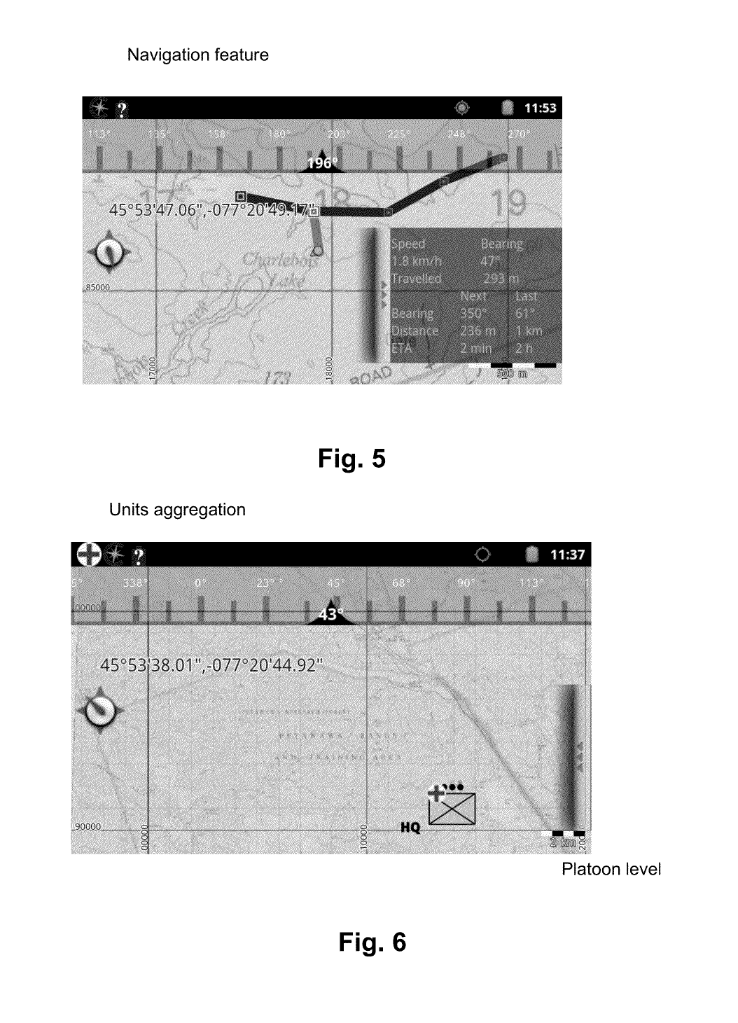

FIG. 5 shows the navigation mode. The users track and location are plotted on the map along with the other parameters, such as speed, distance travelled etc.

FIG. 6 is a map screen showing the user's coordinates and the location of headquarters. This is a platoon level screen, showing the location of a platoon.

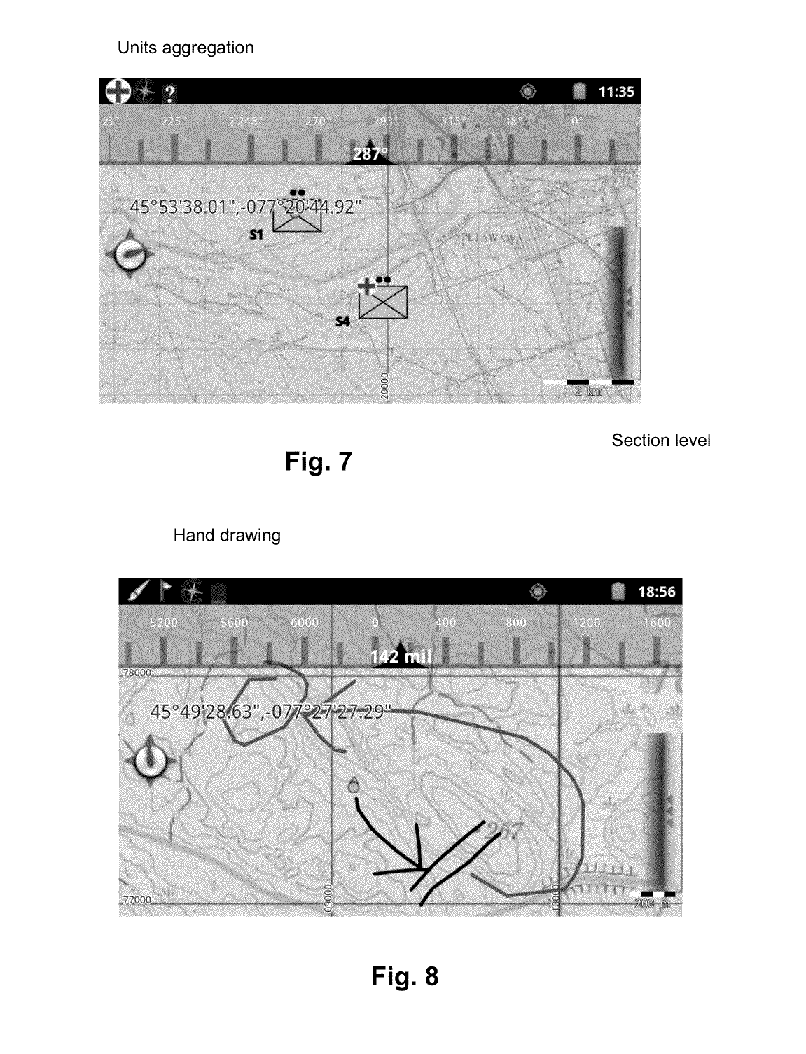

FIG. 7 is a section level screen, which shows the relative positions of sections within on the map display.

FIG. 8 shows a display screen configured to allow the user to add a sketch using the touch screen.

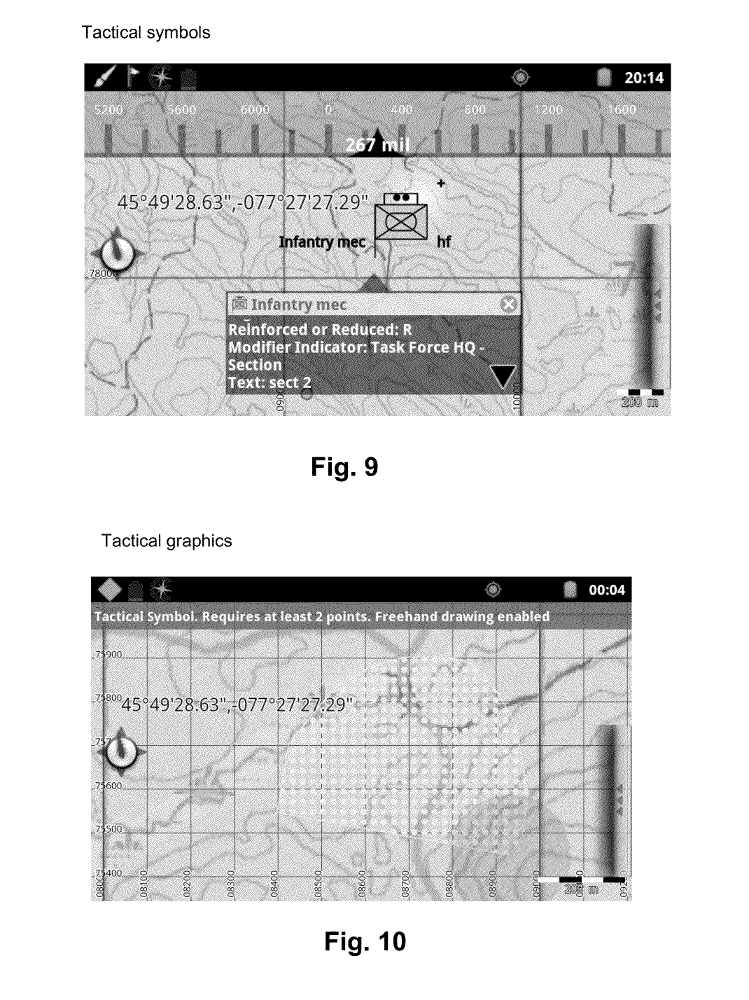

FIG. 9 is a screen showing tactical symbols, for example the location mechanized infantry.

FIG. 10 is a screen that displays tactical graphics with freehand drawing enabled, The user can add sketched over the tactical graphic symbols.

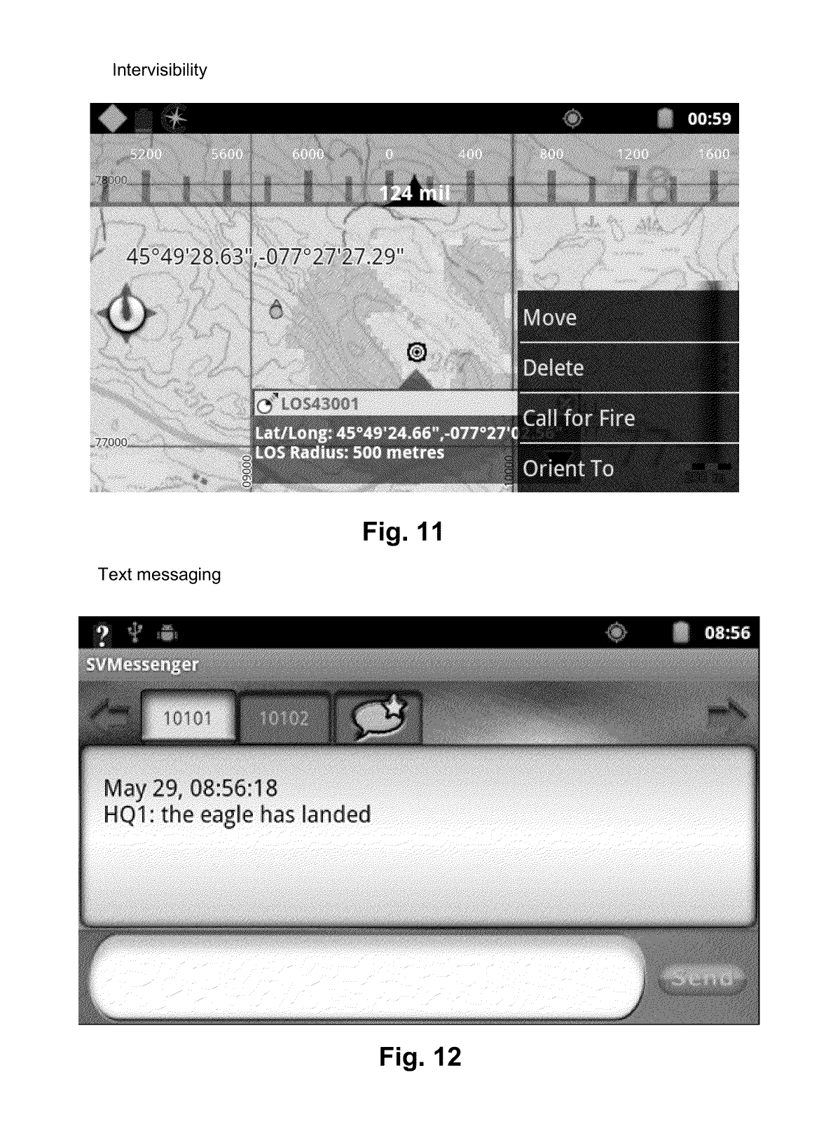

FIG. 11 is another screen showing positional information along with a drop-down menu offering options to the user, such as “call for fire”,

FIG. 12 is a screen showing a message received over the network, in this case, the message being “the eagle has landed”.

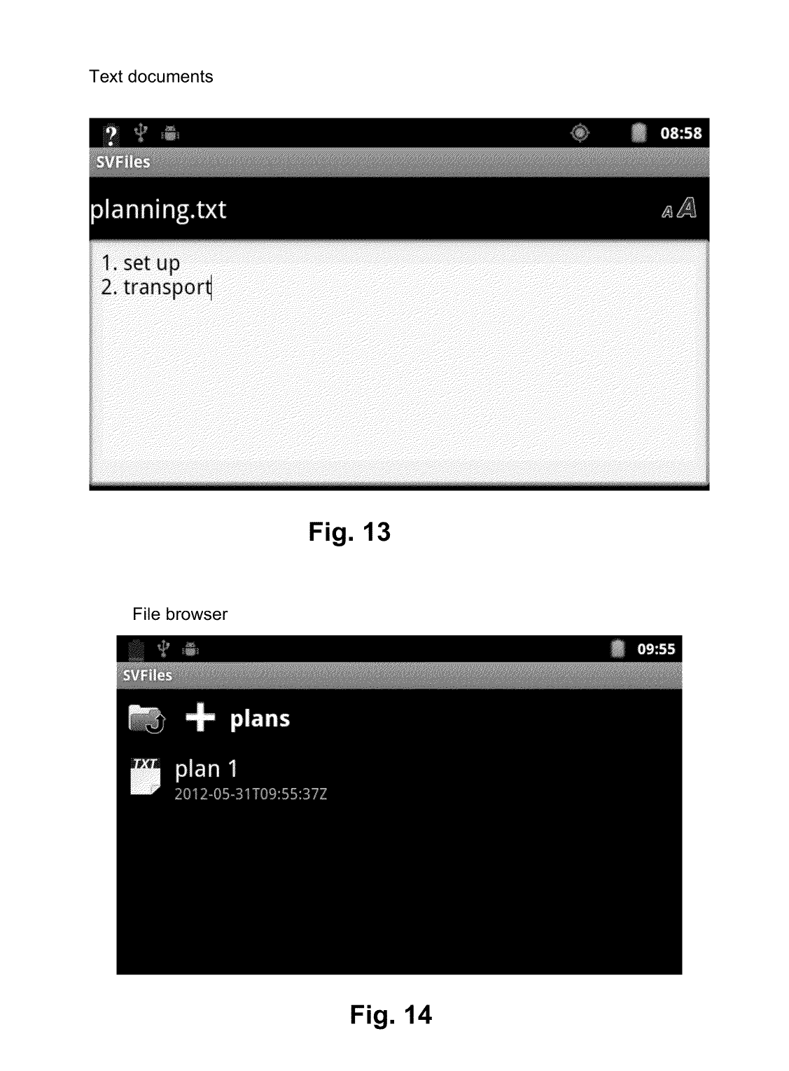

FIG. 13 is a screen offering the user the ability to create text documents, such as battle plans.

FIG. 14 is a screen showing a file browser enabling the user to navigate through the file system.

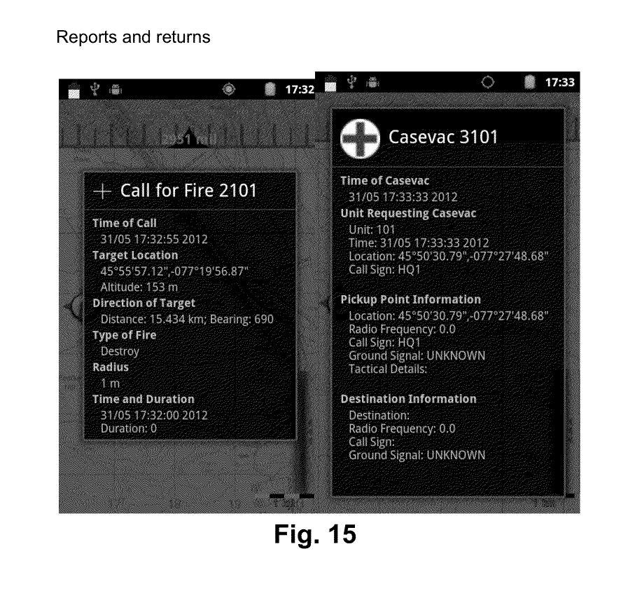

FIG. 15 is a screen showing various reports indicating when certain actions, such as the time of a call for fire, were made.

It will thus be seen that the disclosed combat resource management system provides a complete integrated system all based on a smartphone, preferably based on applications using the Android operating system. Since the system makes use of off-the-shelf hardware, it can be produced at more modest cost compared to custom-designed systems. It offers complete situational awareness based on a smartphone.

It will be understood that the components described herein can be implemented as software modules or apps running on the device operating system.

1. An integrated combat resource management device comprising a smartphone with a display screen and user input device, wherein the smartphone has a set of integrated applications stored therein which when executed provide an interactive display offering dynamic real-time situational awareness information to the user, configuration files containing user-specific profiles, and a launcher application that offers access control and the management of several user profiles on the same smartphone such that upon successful login the appropriate user-specific profile is applied.

2. An integrated combat resource management device as claimed in claim 1, wherein said configuration files contain profiles organized by category of user.

3. An integrated combat resource management device as claimed in claim 1, comprising applications stored therein which when executed present the user with touch screens for accepting instructions or reports for transmission to a base or other users.

4. An integrated combat resource management device as claimed in claim 1, further comprising a network communications module configured to establish a peer-to-peer mesh network with other like smartphones.

5. An integrated combat resource management device as claimed in claim 4, wherein said real-time situational awareness information includes data received from other smartphones in the peer-to-peer network.

6. An integrated combat resource management device as claimed in claim 5, wherein said situational awareness information comprises battlefield information including reported by other smartphones over the peer-to-peer network.

7. An integrated combat resource management device as claimed in claim 6, wherein the battlefield information includes the location of friendly units, and said applications are configured to display the location of said friendly units on a map displayed on the display screen.

8. An integrated combat resource management device as claimed in claim 1, wherein said applications are configured to display said situational awareness information in a configurable set of layers.

9. An integrated combat resource management device as claimed in claim 3, wherein the smartphones are configured to relay messages to smartphones out of range of the originating smartphone.

10. An integrated combat resource management device as claimed in claim 1, further comprising a field management module for invoking various functions comprise at least two of the group consisting of peer-to-peer networking, mapping, navigation, text messaging, and reports and returns.

11. An integrated combat resource management device as claimed in claim 1, wherein the various functions appear on screens related to a current context for the user.

12. An integrated combat resource management device as claimed in claim 3, further comprising a context-sensitive drop-down menu containing preprogrammed requests to permit the user to initiate specific actions within the network by selecting a specific item on the drop down menu.

13. An integrated combat resource management device as claimed in claim 12, wherein the specific item includes a “call for fire”.

14. An integrated combat resource management device as claimed in claim 1, wherein the applications run on an Android operating system.

15. An integrated combat resource management system comprising a plurality smartphones, each smartphone having a display screen and user input device, and having a set of integrated applications stored therein which when executed provide an interactive display offering dynamic real-time situational awareness information to the user, configuration files containing user-specific profiles, and a launcher application that offers access control and the management of several user profiles on the same smartphone such that upon successful login the appropriate user-specific profile, and wherein said smartphones are configured to establish a peer-to-peer network between them.

16. An integrated combat resource management system as claimed in claim 15, wherein said real-time situational awareness information includes data received from other smartphones in the peer-to-peer network.

17. An integrated combat resource management system as claimed in claim 16, wherein said situational awareness information comprises battlefield information including reported by other smartphones over the peer-to-peer network.

18. An integrated combat resource management system as claimed in claim 17, wherein the battlefield information includes the location of friendly units, and said applications are configured to display the location of said friendly units on a map displayed on the display screen.

19. An integrated combat resource management system as claimed in claim 15, wherein said applications are configured to display said situational awareness information in a configurable set of layers.
